(19) United States
(12) Patent Application Publication
(10) Pub. No.: US 2015/0206101 A1
(43) Pub. Date: Jul. 23, 2015

(54) SYSTEM FOR DETERMINING INFRINGEMENT OF COPYRIGHT BASED ON THE TEXT REFERENCE POINT AND METHOD THEREOF

(71) Applicant: OUR TECH CO., LTD., Jeollabuk-do (KR)

(72) Inventors: Kyung Ung CHOI, Jeollabuk-do (KR); Jeong Moon Lee, Jeollabuk-do (KR)

(73) Assignee: OUR TECH CO., LTD., Jeollabuk-do (KR)

(21) Appl. No.: 14/586,892

(22) Filed: Dec. 30, 2014

(30) Foreign Application Priority Data
Jan. 21, 2014 (KR) 10-2014-0007242

(51) Int. Cl. G06Q 10/10; G06F 17/30; G06Q 50/18; G06K 9/00

(52) U.S. Cl. CPC G06Q 10/10; G06K 9/00469; G06K 9/00483; G06K 9/00577; G06F 17/30011; G06F 17/30864; G06F 17/30312; G06Q 50/184; G06K 2009/0059

(57) ABSTRACT

Provided are a system for determining infringement of copyright based on the text reference point and a method thereof. The reference points are extracted automatically by using the text reference point of a window unit instead of a sentence or a paragraph unit, and the infringement location of copyright can be found based on the extracted reference point. The system and method improve the copyright infringement diagnosis speed and provide the expandability of the system by using the search engine in order to index the reference point information.

### BACKGROUND

1. Technical Field

The present invention relates to a system for determining infringement of copyright based on the text reference point and method thereof and more particularly to technology for determining infringement of copyright not by using sentence or paragraph unit but by using a text reference point of a window unit.

2. Description of the Related Art

Regarding technology for determining infringement of copyright, prior art including Korean publication No. 10-2013-0093230 (hereinafter, ‘prior art’), and etc. are disclosed and registered.

The prior art above comprises a management server for receiving a literary work from a user terminal, registering and managing it; a literary work DB for storing the literary work received and registered by the management server; a detection server for collecting contents disclosed in the web sites by crawling for a plurality of websites on the web and detecting the contents determined to be infringement of copyright by comparing the literary work stored in the literary work DB with the collected contents; and a mail server for notifying infringement to the website which discloses the content determined to infringe the copyright based on the result of detection of the detection server.

Meanwhile, people today can easily find information by the development of internet. Internet provides good function helping convenient access to information and also environment in which information can be easily copied and infringe copyright. Accordingly, various methods for determining infringement of copyright have been developed.

One of the conventional methods for determining infringement of copyright uses a method in which a document is divided by sentence unit and regarded as plagiarism if similarity in sentence unit is above critical value. However, a method for determining infringement of copyright by using a sentence has the following problems.

First, a boundary of a sentence can be vague and classification of a sentence can be unclear.

Dividing sentences by a method using punctuation marks, the simplest method can be possible if punctuation marks of a document are done by a professional editor. But this method is not enough for a document written by an ordinary person. If additional sentence division algorithm is used as a method to complement this, it will take more time. Even with a new method, it will be difficult to provide perfect sentence division.

Secondly, in case there are a small number of documents for copyright, system can manage sentence information even with sentence division. But if the number of copyright documents is enlarged in tens of thousands, or hundreds of thousands, information divided by sentence will be considerably enlarged.

In this case, sentence information is too large, thus infringement determining can take too much time. Moreover, services like Google drive supporting writing documents on internet are rapidly increased, documents can be produced wherever the internet can be accessed. Thus the number of documents will be exponentially increased in this environment. Thus, there is need for a method which can control the size of index information for copyright infringement determination and an infringement determination system for increased documents.

### SUMMARY

The present invention is devised by considering those problems above. A reference point is automatically extracted by using a text reference point of window unit unlike sentence or paragraph unit, and copyright infringement position can be known based on an extracted reference point. Faster copyright infringement diagnosis and system expandability can be provided by using a search engine in order to index reference point information.

In order to accomplish this technical objective, the present invention relates to a system for determining infringement of copyright based on the text reference point, comprising a document registration unit for registering an index target document (i.e. a document to be indexed) or a query document (i.e. a document to be queried); an index unit for receiving an index target document from the document registration unit, extracting a text reference unit of window unit, removing overlapped reference point, and transmitting index information to a search engine; a search engine for storing index information and performing search; and an infringement determination unit for receiving a query document from the document registration unit, extracting a text reference point of window unit, selecting a reference point which can be queried to a search engine at one time, and a search word in a selected reference point block, deriving a search result by querying to a search engine based on the selected search word, and determining infringement by finding reference point hash keys identical to corresponding hash keys of a query document and calculating similarity of a reference point block.

Also the index unit comprises a document input module for receiving an index target document; a reference point extraction module for dividing an index target document (Dᵢ) received by the document input module by phrase unit, dividing by window (Wᵢ(s)) of which a window size is s. and extracting a reference point (Fᵢ(m))and a reference point block (Bᵢ(k)) for each window; and an index information selection module for selecting one among overlapped reference points, constructing an index target document (Dᵢ) with reference points and reference point blocks which are not respectively overlapped, and transmitting selected index information to the search engine.

In addition, the search engine stores index information transmitted by the index unit and proceeds actual indexing in case a registration request document is an index target document.

In addition, the search engine is characterized by transforming a reference point (F₁(m)) to an equal length by using a hash function, storing a reference point hash key (Hᵢ(m)) and a reference point block (Bᵢ(k)) as one record, and indexing a reference point hash key and a reference point block when searching with a set of m number of phrases.

In addition, the search engine is characterized by providing the infringement determination unit with the search result according to the query of the infringement determination unit using a selective reference point hash key and search words in case a registration request document is a query document.

In addition, the infringement determination unit comprises a document input module for receiving a query document; a reference point extraction module for dividing a query document (Q) received by the document input module by phrase unit, extracting a reference point (Fᵢ(m)) and a reference point block (Bᵢ(k)) for each window by dividing by window (Wᵢ(s)) of which a window size is s. and transforming a reference point (Fᵢ(m) into a hash key in order to extract a reference point; a reference point selection module for removing overlapped a reference hash key, selecting N reference points which can inquire to a search engine at one time; a search word selection module for selecting a search word from a reference point block selected by the reference point selection module; a query module for deriving the search result by inquiring the search engine based on a reference point hash key and a search word selected by the search word selection module; and a similarity calculation module for finding a query document (QHᵢ(m)) identical to a reference point hash key value (RHᵢ(m)) queried according to the search result by the query module and calculating similarity of a reference point block (SIM(RBᵢ(k), QBᵢ(k))).

And the similarity calculation module determines finally occurrence of copyright infringement to a user and displays the content of the reference point block in case the similarity value of the reference point block (SIM(RBᵢ(k), QBᵢ(k))) is above a critical value.

On the one hand, the present invention relates to a method for determining infringement of copyright based on the text reference point comprises steps of (a) the document registration unit determining whether a registration request document is an index target document or a query document based on user's input signal; (b) the document registration unit transmitting the relevant document to the infringement determination unit in case a registration request document is a query document from the determination result of the step (a); (c) the infringement determination unit receiving a query document (Q), dividing by phrase unit, and dividing by a window (Wᵢ(s)), wherein window size is s; (d) the infringement determination unit extracting a reference point (Fᵢ(m)) and a reference point block (Bᵢ(k)) for every window, and transforming a reference point to a hash key; (e) the infringement determination unit removing an overlapped reference point hash key, selecting N reference points which can be queried at one time to a search engine, and selecting a search word from the selected reference point block; (f) the infringement determination unit deriving the search result by inquiring to the search engine based on a reference point hash key and the selected search word; and (g) the infringement determination unit finding reference point hash keys value queried identical to corresponding hash keys of the query document according to the search result by the query module and calculating similarity of a reference point block, and calculating the similarity of a reference point block (SIM(RBᵢ(k), QBᵢ(k))).

And the similarity calculation module determines finally occurrence of copyright infringement to a user and displays the content of the reference point block in case the similarity value of the reference point block (SIM(RBᵢ(k), QBᵢ(k))) is above a critical value from the result of the step of (g) calculation.

On the other hand, the present invention relates to a method for determining infringement of copyright based on the text reference point comprises steps of (a′) the document registration unit determining whether a registration request document is an index target document or a query document based on user's input signal; (b′) the document registration unit transmitting the relevant document to an index unit in case a registration request document is an index target document from the determination result of the step (a); (c′) the index unit receiving an index target document (Dᵢ), dividing by phrase unit, and separating into windows (Wᵢ(s)) of window size, s; (d′) the index unit extracting a reference point (Fᵢ(m)) and a reference point block (Bᵢ(k)) for every window; (e′) the index unit selecting only the first one among overlapped reference points, constructing with index target document (Dᵢ) and a reference point which are not overlapped and a reference point block and transmitting the selected index information to a search engine; (f′) the search engine transforming a reference point to a hash key by using a hash function, and storing a reference point hash key and a reference point block as one record; and (g′) the search engine indexing a reference point hash key and a reference point block.

According to the present invention as mentioned, the method of a reference point of text in window unit, not in sentence or paragraph unit is used in order to diagnose infringement of copyright. Thus, infringement of copyright can be determined by extracting a reference point unit by window unit regardless of various editing condition of documents.

In addition, according to the present invention, the method for extracting a reference point using a window can store a reference point and a reference point block in the index structure which is adequate for the search engine. Thus, the search engine can be used advantageously.

And the speed of copyright infringement determination can be improved and expandability of the system for can be supported by using a search engine according to the present invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows an overall diagram illustrating conceptually system for determining infringement of copyright based on the text reference point according to the present invention.

FIG. 2 shows a detailed diagram illustrating an index unit according to the present invention.

FIG. 3 shows a detailed diagram illustrating an infringement determination unit according to the present invention.

FIG. 4 shows an overall flow chart for a method for document index according to the present invention.

FIG. 5 shows an overall flow chart for a method for copyright infringement determination according to the present invention.

### DETAILED DESCRIPTION

Specific features and advantages will be clearer from the following detailed description in conjunction with the accompanying drawings. However, in case the detailed description of known functions and configurations related to the present invention unnecessarily obscure the gist of the present invention, that detailed description is omitted.

Hereafter, the present invention is described in detail with the accompanying drawings.

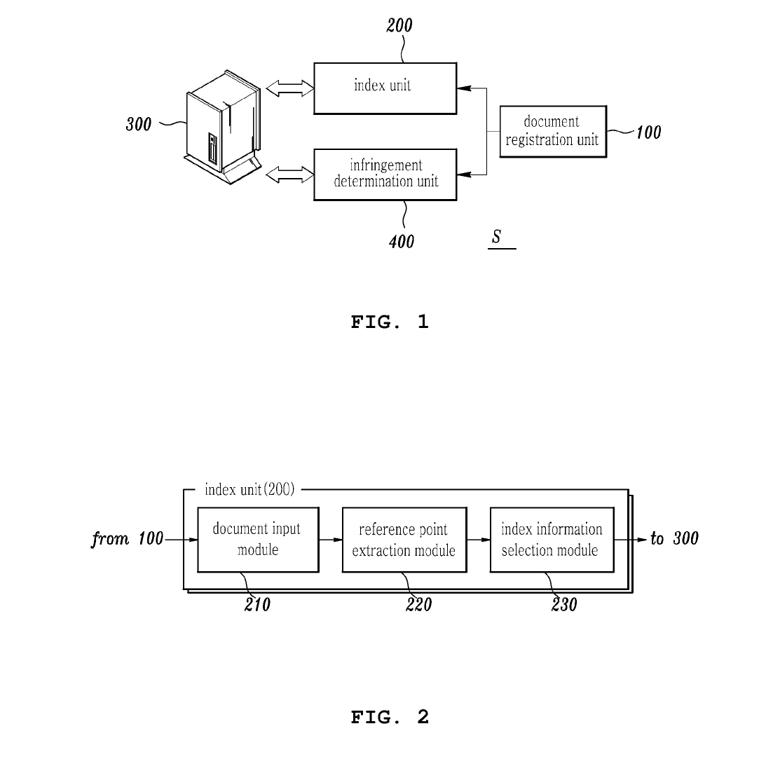

System for determining infringement of copyright based on the text reference point according to the present invention is described in referring to FIGS. 1 to 3 as follows.

In the present invention, a registered document for copyright infringement determination is compared with index and copyright document to perform copyright infringement determination.

First, a step of index and infringement determination performs a function of extracting a text reference point of window unit. The method of a text reference point applied to the present invention operates by using a window (W), a reference point (F), a reference point block (B). And the basic method is described as follows.

Input document (Dᵢ) is defined as follows.

Dᵢ={E₁, E₂, E₃, E₄, . . . , Eₙ}

, wherein Dᵢ is the i-th document to index and Eᵢ is the i-th phrase among E₁˜Eₙ. A phrase is meant to be divided by space character. And additionally symbol or number can be used together.

A document can be defined as a sequential set consisting of N number of phrases, E₁˜Eₙ, as the equation above.

In addition, a window (W) means a subset of sequential phrases to find a reference point in a document (Dᵢ), and the size of a subset is defined as the size of the window.

Wᵢ(s)={Eᵢ, Eᵢ₊₁, . . . , Eᵢ₊ₛ}

, wherein Wᵢ is the i-th window, and s is the size of the window, and Wᵢ(s) is a subset in the i-th window with size s.

For example, Dᵢ={E₁, E₂, E₃, E₄, . . . , E₁₀₀}

As we assume there is a document (Dᵢ) defined with E₁˜E₁₀₀, Wᵢ(30), window size s=30, can be indicated in Table 1.

TABLE 1

| Window number | Window set |
|---|---|
| W₁ (30) | {E₁, E₂, E₃, E₄, . . . E₂₇, E₂₈, E₂₉, E₃₀} |
| W₂ (30) | {E₂, E₃, E₄, E₅, . . . E₂₈, E₂₉, E₃₀, E₃₁} |
| W₃ (30) | {E₃, E₄, E₅, E₆, . . . E₂₉, E₃₀, E₃₁, E₃₂} |
| W₄ (30) | {E₄, E₅, E₆, E₇, . . . E₃₀, E₃₁, E₃₂, E₃₃} |
| W₅ (30) | {E₅, E₆, E₇, E₈, . . . E₃₁, E₃₂, E₃₃, E₃₄} |
| W₆ (30) | {E₆, E₇, E₈, E₉, . . . E₃₂, E₃₃, E₃₄, E₃₅} |
| W₇ (30) | {E₇, E₈, E₉, E₁₀, . . . E₃₃, E₃₄, E₃₅, E₃₆} |
| W₈ (30) | {E₈, E₉, E₁₀, E₁₁, . . . E₃₄, E₃₅, E₃₆, E₃₇} |
| . . . | . . . |
| W₇₀ (30) | {E₇₀, E₇₁, E₇₂, E₇₃, . . . E₉₆, E₉₇, E₉₈, E₉₉} |
| W₇₁ (30) | {E₇₁, E₇₂, E₇₃, E₇₄, . . . E₉₇, E₉₈, E₉₉, E₁₀₀} |

In the present invention, a registered document for copyright infringement determination is compared with index and copyright document to perform copyright infringement determination.

If a window (W) is determined, a reference point (F) is determined for the window.

A reference point (F) means a sequential set of a phrase, wherein the lengths sum of m number of sequential phrases. If a reference point (F) is determined, the set of sequential phrases including a reference point, k number of phrases each on the left and the right side of the reference point is defined as a reference point block (B).

SUMⱼ(m)=Σₓ₌ⱼ^{j+m-1}Len(Eₓ)

Fᵢ(m)=MAX(SUMⱼ(m):j=i, i+1, i+2, . . . , i+s−m)

Bᵢ(k)={Eⱼ₊ₖ, . . . , Eⱼ₋₂, Eⱼ₋₁, Eⱼ, Eⱼ₊₁, Eⱼ₊₂, . . . , Eⱼ₊ₖ}, k>m

, wherein SUMⱼ(m) is the length which summates m phrases from the j-th phrase.

A reference point Fᵢ(m) calculates the sequential set of the phrase of which SUMⱼ(m) is the largest in Wᵢ(s) by MAX function.

A reference point block Bᵢ(k) means the set of sequential phrases including the size of k each on the left and the right side of the reference point including the reference point Fᵢ(m). For example Table 1, the sequential set in which the sum of length of 3 phrases is the maximum in Wᵢ(30), i.e. Fᵢ(3) is determined as a reference point, and 5 phrases each on the left and the right side of the reference point, i.e. Bᵢ(5) is defined as a reference point block. Then, Fᵢ(3) and Bᵢ(5) are shown in Table 2.

TABLE 2

| Window | | |
|---|---|---|
| number | Reference point (example) | Reference point block (example) |
| W₁(30) | F₁(3) = {E₁₀, E₁₁, E₁₂} | B₁(5) = {E₅, . . . , E₁₀, E₁₁, |
| | | E₁₂, . . . , E₁₅} |
| W₂(30) | F₂(3) = {E₁₀, E₁₁, E₁₂} | B₂(5) = {E₅, . . . , E₁₀, E₁₁, |
| | | E₁₂, . . . , E₁₅} |
| W₃(30) | F₃(3) = {E₁₀, E₁₁, E₁₂} | B₃(5) = {E₅, . . . , E₁₀, E₁₁, |
| | | E₁₂, . . . , E₁₅} |
| W₄(30) | F₄(3) = {E₁₀, E₁₁, E₁₂} | B₄(5) = {E₅, . . . , E₁₀, E₁₁, |
| | | E₁₂, . . . , E₁₅} |
| . . . | . . . | . . . |
| W₄₀(30) | F₄₀(3) = {E₄₇, E₄₈, E₄₉} | B₄₀(5) = {E₄₂, . . . , E₄₇, E₄₈, |
| | | E₄₉, . . . , E₅₂} |
| W₄₁(30) | F₄₁(3) = {E₄₇, E₄₈, E₄₉} | B₄₁(5) = {E₄₂, . . . , E₄₇, E₄₈, |
| | | E₄₉, . . . , E₅₂} |
| W₄₂(30) | F₄₂(3) = {E₄₇, E₄₈, E₄₉} | B₄₂(5) = {E₄₂, . . . , E₄₇, E₄₈, |
| | | E₄₉, . . . , E₅₂} |
| . . . | . . . | . . . |
| W₇₀(30) | F₇₀(3) = {E₈₀, E₈₁, E₈₂} | B₇₀(5) = {E₇₅, . . . , E₈₀, E₈₁, |
| | | E₈₂, . . . , E₈₅} |
| W₇₁(30) | F₇₁(3) = {E₈₀, E₈₁, E₈₂} | B₇₁(5) = {E₇₅, . . . , E₈₀, E₈₁, |
| | | E₈₂, . . . , E₈₅} |

In Table 2 above, F₁(3) is taken as the set of the maximum length phrases {E₁₀, E₁₁, E₁₂} for example in case SUMⱼ(3), j=1, 2 . . . , 28 in W₁(30) is assumed as shown in Table 3. If there are duplicate maximum values of SUMⱼ(3), select the first maximum value.

TABLE 3

| | | Sum of lengths of phrases |
|---|---|---|
| SUMⱼ(3) | Equation | (example) |
| SUM₁(3) | Len(E₁) + Len(E₂) + Len(E₃) | 7 |
| SUM₂(3) | Len(E₂) + Len(E₃) + Len(E₄) | 7 |
| SUM₃(3) | Len(E₃) + Len(E₄) + Len(E₅) | 8 |
| . . . | . . . | . . . |
| SUM₉(3) | Len(E₉) + Len(E₁₀) + Len(E₁₁) | 10 |
| SUM₁₀(3) | Len(E₁₀) + Len(E₁₁) + Len(E₁₂) | 13 |
| SUM₁₁(3) | Len(E₁₁) + Len(E₁₂) + Len(E₁₃) | 12 |
| . . . | . . . | . . . |
| SUM₂₆(3) | Len(E₂₆) + Len(E₂₇) + Len(E₂₈) | 13 |
| SUM₂₇(3) | Len(E₂₇) + Len(E₂₈) + Len(E₂₉) | 11 |
| SUM₂₈(3) | Len(E₂₈) + Len(E₂₉) + Len(E₃₀) | 9 |

B₁(5) includes 5 phrases each on the left and the right side of E₁₀, reference for example.

If extraction of a reference point and a reference point block is done, Dᵢ consisting of n number of phrases can be redefined with a reference point (F) and a reference point block (B) as follows. s is the size of a window, m is the number of a reference point phrases, and k is the size of a reference point block.

Dᵢ={(F₁(m), B₁(k)), (F₂(m), B₂(k)), . . . , (Fₙ₋ₛ₊₁(m), Bₙ₋ₛ₊₁(k))}

After Dᵢ is configured to comprise a reference point and a reference point block, overlapped reference points are removed in Dᵢ and Dᵢ is configured to be indexed by a search engine. For example from Table 3, W₁(30), W₂(30), W₃(30), and W₄(30) are same, thus only W₁(30) is selected. As W₄₀(30), W₄₁(30), and W₄₂(30) are same, only W₄₀(30) is selected. As W₇₀(30), and W₇₁(30) are same, only W₇₀(30) is selected. Duplication from the Table above is removed, and can be defined or expressed as follows.

Dᵢ={(F₁(3), B₁(5)), . . . , (F₄₀(3), B₄₀(5)), (F₇₀(3), B₇₀(5))}

When the unduplicated reference point and reference point block information are indexed for a search engine, indexed documents are defined by attaching D in front of F, B, and query documents are defined by attaching Q in front of F, B as follows.

Dᵢ={(DF₁(m), DB₁(k)), . . . , (DF₂₀(m), DB₂₀(k)), . . . }

Q={(QF₁(m), QB₁(k)), (QF₅₀(m), QB₅₀(k)), . . . }

A query document, Q, can be also expressed identically with a reference point and a reference point block, and the size of window (s), the number of phrases of a reference point (m), the size of a reference point block (k), and etc. should be the same as the configuration of index.

For example, assuming that the part copying DB₂₀(k) of a document Dᵢ in a query document Q is QB₅₀(k), the reference point of QF₅₀(m) will be identical to one of DF₂₀(m). Thus, if searching QF₅₀(m) in a query document Q, DF₂₀(m) with the same reference point will be able to be searched.

However, there can be a plurality of reference points which are identical to QF₅₀(m) in a document Dᵢ besides to DF₂₀(m). In this case, a search word randomly selected from a reference point block QB₅₀(k) is queried to the filtered reference point block after filtering with a reference point such as QF₅₀(m).

Then, the search engine will show RBᵢ(k) as result which has a high similarity with the search word. RBᵢ(k) means the reference point block which is ranked i-th in the similarity ranking of searched reference point blocks. Herein, infringement determination can be determined by selecting RBᵢ(k) of which similarity is above a critical value and recalculating the similarity between QB₅₀(k) and the reference point block. Thus, indexing based on the reference point can limit to the same reference point instead of searching all reference points when searching so that searching speed can be improved and infringement location can be known.

FIG. 1 is an overall diagram illustrating conceptually a system for determining infringement of copyright based on the text reference point (S). A document registration unit 100, an index unit 200, a search engine 300, and an infringement determination unit 400 are included as illustrated.

On the other hand, the system for determining infringement of copyright based on the text reference point (S) according to the present invention stores information related to copyright document registration, user login, access login, etc. in the internal management database, manages them, and supports API library so that it can be also accessed by conventional applications developed by program languages such as C#, Java, etc. not by a web browser.

A document registration unit 100 registers a query target document or a query document.

At this time, the document registration module 100 supports the user interface as a web service module, the document registration unit 100 can be accessed by using a web browser.

On the other hand, the system for determining infringement of copyright based on the text reference point (S) performs index by using an index unit 200 in case a document is needed to be registered in the system. And the system performs infringement determination by infringement determination unit 400 in case a query document is compared with a copyright document in the system.

Thus, a document registration unit 100 determines if the query document is an index target document or a query document based on user input signal.

An index unit 200 receives an index target document (Dᵢ) from a document registration unit 200, extracts a text reference point of a window unit, removes a duplicate reference point, performs a function to transmit index information to the search engine, and comprises a document input module 210, a reference point extraction module 220, and an index information selection module 230 as illustrated in FIG. 2.

Specifically, a document input module 210 receives an index target document. At this time, the document input module 210 receives an index target document from the document registration unit 100 by using a web browser or API.

A reference point extraction module 220 divides an index target document (Dᵢ) received by the document input module 210 into a phrases unit as shown in Equation 1, and divides it into a window (Wᵢ(s)) with window size, s in order to extract a reference point.

Dᵢ={E₁, E₂, E₃, E₄, . . . , Eₙ} [Equation 1]

Window size (s) affects the number of extracted reference points.

As the size of a window gets larger, the number of reference points gets smaller. As the size of a window get smaller, the number of reference points is increased. In case the size of a window is large, it can be easy to find an infringement document which fully copies. But percentage to fail infringement determination for a part copy of the small region goes high. On the contrary, in case the size of a window is small, it is possible to make infringement determination for fully copied infringement document to a partly copied infringement document. But in this case a large number of reference points are extracted. Thus, the size of a wind should be determined by determining to what extent a window size can determine the size of a part copy and the total number of reference points which can be allowed by the system.

In addition, the reference point extraction module 220 extracts a reference point (Fᵢ(m)) and reference point block (Bᵢ(k)) for each window. Accordingly, the index target document (Dᵢ) is defined as the following Equation 2.

Dᵢ={(F₁(m), B₁(k)), (F₂(m), B₂(k), . . . , (Fₙ₋ₛ₊₁(m), Bₙ₋ₛ₊₁(k))} [Equation 2]

The index selection module 230 selects a duplicated reference point and removes it, thus comprises unduplicated reference points and reference point blocks.

It is determined as reference point (Fᵢ(m)) what has the largest sum of lengths of m phrases in a window(Wᵢ(s)). Thus, even if the window moves by a phrase, the change of the reference point doesn't often occur.

Accordingly, the index information selection selects only one among duplicate reference points, constructs an index target document (Dᵢ) with a unduplicated reference point and a reference point block, and transmits selected index information to a search engine 300.

For example, assuming that the unduplicated selected reference points in the index target document (Dᵢ) are F₁(m), F₂₀(m), F₅₀(m), and F₈₀(m), the index target document (Dᵢ) is shown as the following Equation 3.

Dᵢ={(Fᵢ(m), B₁(k)), (F₂₀(m), B₂₀(k)), (F₅₀(m), B₅₀(k)), (F₈₀(m), B₈₀(k))} [Equation 3]

A search engine 300 performs index information storage and search of a document.

Herein, in case that a registration request document is a query target document, the index information transmitted by an index unit 200 is stored, and actual index is performed.

At this time, when the search engine 300 performs searching with the set of m number of phrases set in order to increase the search efficiency, the reference point (F₁(m)) is transformed to the same length by using a hash function as shown in Equation 4.

Hᵢ(m)=hash(Fᵢ(m)) [Equation 4]

That is, if m number of phrases included by a reference point (Fᵢ(m)) is inputted into a hash function, the search engine 300 connects all the separate inputted phrases into one and transforms it into a hash key and returns it.

For example, F₁(m), F₂₀(m), F₅₀(m), and F₈₀(m) are selected as the reference points of the document above. In order to store the document in the search engine, the reference points are transformed to hash keys.

Dᵢ={Hᵢ(m), B₁(k)), (H₂₀(m), B₂₀(k)), (H₅₀(m), B₅₀(k)), (H₈₀(m), B₈₀(k))} [Equation 5]

In addition, the search engine 300 stores a reference point hash key (Hᵢ(m)) and a reference point block (Bᵢ(k)) as one record, and indexes a reference point hash key and a reference point block.

Accordingly, a reference point hash key indexes a hash key value, and a reference point block indexes a phrase included by a reference point block, Eᵢ.

And, in case a registration request document is a query document, a search engine 300 provides an infringement determination unit 400 with the search result according to the query of an infringement determination unit 400 by using selected reference point hash key and search word.

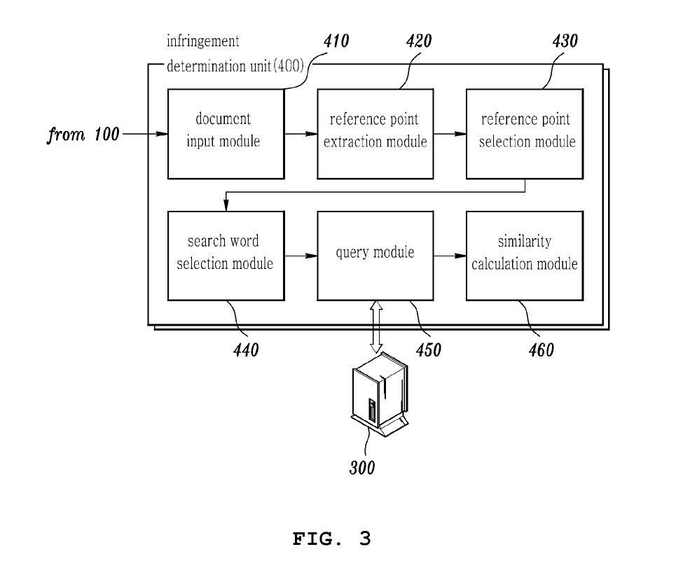

The infringement determination unit 400 receives a query document (Q) from a document registration unit 100, extracts a text reference point of a window unit, selects a search word from a reference point which can be queried to a search engine 300 at a time or a reference point block, draw the search result by inquiring to the search engine 300 based on the selected search word, performs infringement determination by finding reference point hash keys identical to corresponding hash keys of the query document, and calculating the similarity of the reference point block, and comprises a document input module 410, a reference extraction module 420, a reference point selection module 430, a search word selection module 440, a query module 450, and a similarity calculation module 460 as illustrated in FIG. 3.

Specifically, a document input module 410 receives a query document.

At this time, the document input module 410 receives the query document from the document registration unit 100 by using a web browser or API.

The query document (Q) can be identically expressed with a reference point and a reference point block, and the size of a window (s), the number of phrases of a reference point (m), and the size of a reference point block should be should be identical to the index configuration.

Thus, a reference point extraction module 420 divides a query document (Q) into a phrase unit as shown in the following Equation 6 through the document input module 410.

Q={E₁, E₂, E₃, E₄, . . . , Eₙ} [Equation 6]

In addition, the reference point extraction module 420 extracts a reference point and a reference point block for each window by separating into windows (Wᵢ(s)) of window size, s, and can redefine a query document (Q) as shown in Equation 7 by transforming a reference point to a hash key.

Q={(H₁(m), B₁(k)), (H₂(m), B₂(k)), . . . , (Hₙ₋ₛ₊₁(m), Bₙ₋ₛ₊₁(k)} [Equation 7]

In this way, after a query document (Q) is redefined with a reference point hash key and a reference point block, the reference point selection module 430 removes a duplicate reference point hash key, and selects N reference points which can be queried to the search engine 300 at one time.

The search engine 300 has the maximum value that can be queried for a reference point hash key and a search word query with OR condition at one time. N reference points should be selected such that N reference points can be less than the maximum value that can be queried at one time.

For example, if the number of unduplicated reference points extracted from a query document (Q) is 1000, and the search engine can take 100 at maximum for query, 1 at minimum to 100 at maximum can be specified for reference point selection for query.

If 100 reference points are specified, the entire search for 1000 reference points of a query document (Q) can be done by repeating the search 10 times at maximum. Searching all the reference points increases search time, but it can increase the accuracy of copyright infringement determination. When determining a fully copied copyright infringement document, it is possible to try one time at minimum. Thus, the number of selected reference points and the number of repetitions should be determined depending on the purpose of infringement determination usage.

A search word selection module 440 selects a search word from the reference point block selected by the reference point selection module 430.

The search engine can receive a query with only a reference point hash key, but in case there is a plurality of the identical reference hash keys, reference point block should be investigated for all the search result.

However, if a critical value is determined to perform infringement determination only for the case above the critical value, searching speed can be improved because in case of querying with a search word, the search word and indexed reference point blocks can be sorted in order of high similarity.

Assuming that a reference point block is a single document in order to select a search word, tf-idf weighted value can be used.

$${r}_{ie} = {f}_{ie} * log ( \frac{N}{{n}_{e}} ) , \qquad [ Equation 8 ]$$

wherein rᵢₑ is tf-idf weighted value of a phrase e in the i-th reference point block (Bᵢ(k)), fᵢₑ is appearance frequency of the phrase e in the i-th reference point block (Bᵢ(k)), N is the number of selected reference point blocks, and nₑ is the number of reference point blocks in which the phrase e appears.

Eᵢ, N/2 number phrase(s), with a larger weighted value rᵢₑ, is selected. And in case rᵢₑ is the same, the phrase with larger length is selected first.

It is determined whether the selected phrase Eᵢ is included in N number of reference point blocks by more than one. If Eᵢ doesn't exist in the reference point blocks, the phrase of the largest length is selected from the reference point block and added to search words within N number at maximum.

If the selected search words become N number at maximum, more search word is not added.

The query module 450 inquires to the search engine 300 in order to draw the search result based on the search word selected by the search word selection module 440 and a reference point hash key.

If the reference point block indexed with OR operator is searched after filtering by searching a reference hash key with OR operator in the search engine 300, the search result can be acquired in order of high similarity. Search speed can be improved if a critical value is determined and infringement is determined only for cases with similarity above the critical value, because the search result can be sorted in order of high similarity.

n number of search results R is expressed by attaching R in front of a reference hash key and a reference point block (B) as shown in the following Equation 9.

R={(RH₁(m), RB₁(k)), (RH₂(m), RB₂(k)), . . . , (RHₙ(m), RBₙ(k)} [Equation 9]

, wherein RHᵢ(m) is a searched reference point hash key placed i-th in the similarity ranking.

The similarity calculation module 460 finds calculates the similarity of the reference point block (SIM(RBᵢ(k), QBᵢ(k))) as shown in the following Equation 10 by finding a reference point hash key value (RHᵢ(m)) identical to the corresponding hash key of the query document (QHᵢ(m)) according to the search result.

SIM(RBᵢ(k), QBᵢ(k))=|RBᵢ(k)∩QBᵢ(k)|/|QBᵢ(k)| [Equation 10]

Herein, |QBᵢ(k)| is the number of phrases included in the reference point block, |RBᵢ(k)∩QBᵢ(k)| is the intersection of the reference point blocks of the query document QBᵢ(k) and RBᵢ(k).

That is, the similarity calculation module 460 determines finally copyright infringement to the user occurs in case that the value of SIM(RBᵢ(k), QBᵢ(k)) is above the critical value.

As described above, the information processed by the infringement determination unit 400 is transmitted to the search engine 300 in which the actual storage of index information and the search are processed.

At this time, commercial products can be used for the search engine 300, and open source search engine can be used. For example, with Solr search engine under development by Apache Software Foundation can compose index structure in schema form and support a variety of search conditions. In addition, it supports cloud such that index of large quantity of documents can be performed. Thus, the copyright infringement determination system can be organized by selecting a search engine 300 supporting search function and index function requiring an infringement determination unit among a variety of conventional search engines 300.

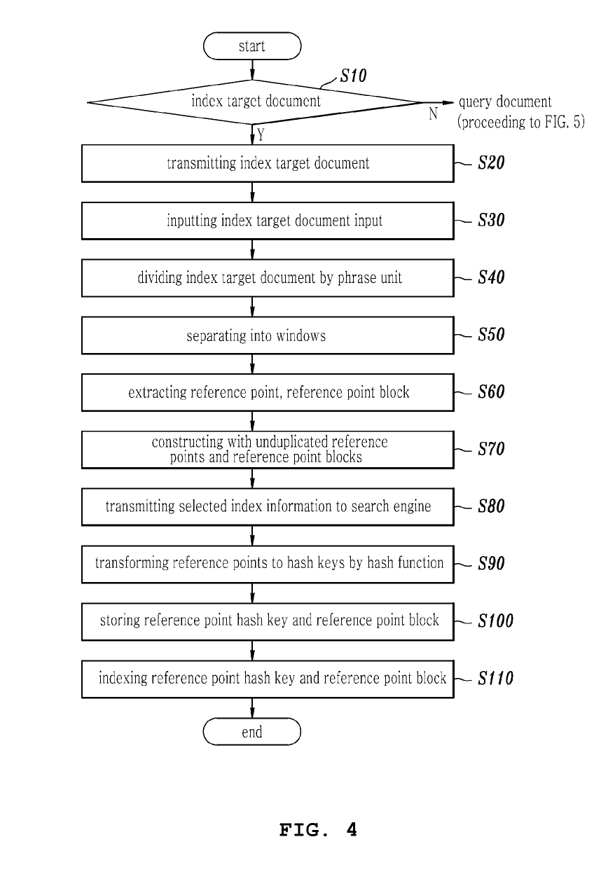

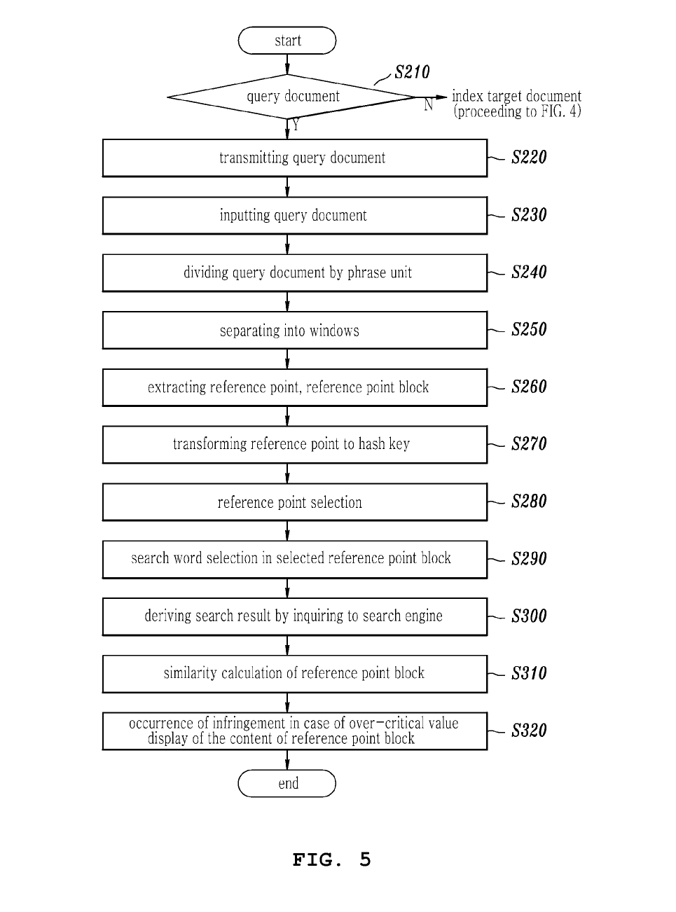

Hereafter, the method for document index and the method for copyright infringement determination using the system described above are described in referring to FIGS. 4 and 5 as follows.

First, the method for document index is described in referring to FIG. 4 as follows.

The document registration unit 100 determines if the query document is an index target document or a query document based on user input signal (S10).

The document registration unit 100 transmitting the relevant document to the index unit 200 in case a registration request document is an index target document from the determination result of step S10 (S20).

The document input module 210 of the index unit 200 receives an index target document (S30).

In addition, the reference point extraction module 220 divides the index target document (Dᵢ) received by the document input module 210 by phrase unit (S40), and divides by a window (Wᵢ(s)) with window size s (S50).

In addition, the reference point extraction module 220 extracts the reference point (Fᵢ(m)) and the reference point block (Bᵢ(k)) (S60), the index information selection module 230 selects only one among overlapped reference points, reconstructs the index target document with unduplicated reference points and reference point blocks (S70), and transmits the selected index information to the search engine 300 (S80).

Hereafter, the search engine 300 transforms a reference point to a hash key by using a hash function (S90), stores a reference point hash key (Hᵢ(m)) and a reference point block (Bᵢ(k)) as one record (S100), and indexes the reference point hash key and the reference point block (S110).

The method for copyright infringement determination is described in referring to FIG. 5 as follows.

The document registration unit 100 determines if the query document is an index target document or a query document based on user input signal (S210).

In case the registration request document is the query document according to the result of step (S210), the relevant document is transmitted to the infringement determination unit 400 (S220).

The document input module 410 of the infringement determination unit 400 receives the query document (S230).

In addition, the infringement determination unit 400 divides the query document (Q) by phrase unit through the document input module (410) in order to extract the reference point, and divides by a window (Wᵢ(s)) with window size, s (S250).

In addition, the reference point extraction module 420 extracts the reference point (Fᵢ(m)) and the reference point block (Bᵢ(k)) for each window (S260), and transforms the reference point to the hash key (S270).

After that, the reference point selection module 430 removes the duplicate reference hash key, selects N number of reference points which can be queried to the search engine 300 at one time (S280), and the search word selection module 440 selects the search word in the selected reference point block (S290).

In addition, the query module 450 draws the search result by inquiring to the search engine 300 based on the reference hash key and the selected search word (S300).

The similarity calculation module 460 finds reference point hash keys identical to corresponding hash keys of the query document and calculates the similarity SIM(RBᵢ(k), QBᵢ(k))) of the reference point block (S310).

And in case the similarity value of the reference point block (SIM(RBᵢ(k), QBᵢ(k)) is above a critical value, the similarity calculation module determines finally occurrence of copyright infringement to a user and displays the content of the reference point block (S320).

As described above, the system for determining infringement of copyright based on the text reference point and method thereof according to the present invention can extract automatically the reference point by using the reference point extraction method using the window, and diagnose the document in which part the copyright infringement occurs.

In addition, conventional diagnosis method of sentence unit has a problem that the boundary of the sentence is too vague to divide sentence by sentence. This problem can be resolved by using the window method(method using the window unit), and the infringement determination speed can be improved, and the system expandability of the system can be provided to index a large quantity of documents by storing reference points in the index structure to be used by the search engine.

Although the present invention has been described in conjunction with the preferred embodiments which illustrate the technical spirit of the present invention, it will be apparent to those skilled in the art that the present invention is not limited only to the illustrated and described configurations and operations themselves but a lot of variations and modifications are possible without departing from the scope of the spirit of the invention. Accordingly, all of appropriate variations, modifications and equivalents are considered to pertain to the scope of the present invention.

What is claimed is:

1. A system for determining infringement or non-infringement of copyright based on a text reference point comprising:
a document registration unit for registering an index target document or a query document;
an index unit for receiving an index target document from the document registration unit, extracting a text reference point of window unit, removing overlapped reference point, and transmitting index information to a search engine;
a search engine for storing index information and performing search; and
an infringement determination unit for receiving a query document from the document registration unit, extracting a text reference point thereof by window unit, selecting a reference point and a search word in a selected reference point block with which a query is made at a time, deriving search result by querying the search engine based on the selected search word, and determining infringement/non-infringement by finding reference point hash keys identical to corresponding hash keys of the query document and calculating similarity of the reference point block.

2. The system according to claim 1, wherein the index unit comprises a document input module for receiving an index target document;
a reference point extraction module for dividing an index target document (Dᵢ) received by the document input module by phrase unit, separating them into windows (Wᵢ(s)) of window size, s and extracting a reference point (Fᵢ(m))and a reference point block (Bᵢ(k)) for each window; and
an index information selection module for selecting one among overlapped reference points, constructing the index target document (Dᵢ) with the reference points and the reference point blocks which are not overlapped, and transmitting selected index information to the search engine.

3. The system according to claim 1, wherein the search engine stores index information transmitted by the index unit, and proceeding actual indexing in case a registration request document is an index target document.

4. The system according to claim 1, wherein the search engine transforms reference point (F₁(m)) to an equal length by using a hash function, stores a reference point hash key (Hᵢ(m)) and a reference point block (Bᵢ(k)) as one record, and indexes the reference point hash key and the reference point block when searching with a set of m number of phrases.

5. The system according to claim 1, wherein the search engine provides the infringement determination unit with the search result according to the query of the infringement determination unit using a selected reference point hash key and a search word in case a registration request document is a query document.

6. The system according to claim 1, wherein the infringement determination unit comprises a document input module for receiving a query document;
a reference point extraction module for dividing a query document (Q) received by the document input module by phrase unit, extracting a reference point (Fᵢ(m)) and a reference point block (Bᵢ(k)) for each window by separating into windows (Wᵢ(s)) of window size is s. and transforming a reference point (Fᵢ(m)) into a hash key in order to extract a reference point;
a reference point selection module for removing overlapped reference hash keys, keeping the first one from the overlapped ones, and selecting N number of reference points which can be queried to the search engine at one time;
a search word selection module for selecting a search word from the reference point block selected by the reference point selection module;
a query module for deriving the search result by inquiring the search engine based on a reference point hash key and a search word selected by the search word selection module; and
a similarity calculation module for finding a reference point hash key value (RHᵢ(m)) identical to a corresponding hash key value of the query document (QHᵢ(m)) and calculating similarity of a reference point block (SIM(RBᵢ(k), QBᵢ(k))) according to the search result by the query module.

7. The system according to claim 6, wherein similarity calculation module determines finally occurrence of copyright infringement to a user and displays the content of the reference point block in case the similarity value of the reference point block (SIM(RBᵢ(k), QBᵢ(k)) is above a critical value.

8. A method for determining infringement of copyright based on the text reference point comprising:
step (a) of the document registration unit determining based on user's input signal whether a registration request document is an index target document or a query document;
step (b) of the document registration unit transmitting the document to the infringement determination unit in case the registration request document is a query document from the determination result of the step (a);
step (c) of the infringement determination unit receiving a query document (Q), dividing by phrase unit, and separating into windows (Wᵢ(s)), of window size, s;
step (d) of the infringement determination unit extracting a reference point (Fᵢ(m)) and a reference point block (Bᵢ(k)) for every window, and transforming a reference point (Fᵢ(m)) to a hash key;
step (e) of the infringement determination unit removing overlapped reference point hash keys to leave the first one among the overlapped ones, selecting N number of reference points which can be queried at one time to a search engine, and selecting a search word from the selected reference point block;
step (f) of the infringement determination unit deriving the search result by querying to the search engine based on a reference point hash key and the selected search word; and
step (g) of the infringement determination unit finding a reference point hash key value queried identical to a corresponding hash key of a query document according to the search result and calculating the similarity of a reference point block (SIM(RBᵢ(k), QBᵢ(k))).

9. The method according to claim 8, wherein the infringement determination unit determines finally occurrence of copyright infringement to a user and displays the content of the reference point block in case the similarity value of the reference point block (SIM(RBᵢ(k), QBᵢ(k)) is above a critical value from the calculation result of the step (g).

10. A method for determining infringement of copyright based on the text reference point comprising:
step (a′) of the document registration unit determining based on user's input signal whether a registration request document is an index target document or a query document;
step (b′) of the document registration unit transmitting the document to an index unit in case a registration request document is an index target document from the determination result of the step (a);
step (c′) of the index unit receiving an index target document (Dᵢ), dividing by phrase unit, and separating into windows (Wᵢ(s)) of window size, s;
step (d′) of the index unit extracting a reference point (Fᵢ(m)) and a reference point block (Bᵢ(k)) for every window;
step (e′) of the index unit reconstructing an index target document (Dᵢ) with reference points and reference point blocks which are not overlapped by selecting only one among overlapped reference points and transmitting the selected index information to a search engine;
step (f′) of the search engine transforming a reference point to a hash key by using a hash function, and storing the reference point hash key and the reference point block as one record; and
step (g′) of the search engine indexing a reference point hash key and a reference point block.
